(19) United States
(12) Patent Application Publication
(10) Pub. No.: US 2026/0158459 A1
(43) Pub. Date: Jun. 11, 2026

(54) SYSTEM AND DEVICE FOR COATING USING A HELICAL CONVEYOR

(71) Applicant: Coating Place, Incorporated, Verona, WI (US)

(72) Inventor: Jared McDonald, Madison, WI (US)

(21) Appl. No.: 19/414,699

(22) Filed: Dec. 10, 2025

Related U.S. Application Data
(60) Provisional application No. 63/730,149, filed on Dec. 10, 2024.

(51) Int. Cl. B01J 2/00

(52) U.S. Cl. CPC B01J 2/006

(57) ABSTRACT

A novel and advantageous system for coating particles is provided. Particularly, a novel and advantageous system for coating particles using a helical conveyor is provided. Even more particularly, a novel and advantageous system for coating particles using a helical conveyor wherein vertical movement and cycling of material is generally done by the helical conveyor is provided.

### CROSS-REFERENCE TO RELATED APPLICATION

This application claims the benefit of and priority to U.S. Provisional Application No. 63/730,149, filed on 10 Dec. 2024, which is incorporated herein by reference.

### FIELD OF THE INVENTION

The present disclosure relates to a novel and advantageous system for coating particles. Particularly, the present disclosure relates to a novel and advantageous system for coating particles using a helical conveyor. Even more particularly, the present disclosure relates to a novel and advantageous system for coating particles using a helical conveyor wherein vertical movement and cycling of material is generally done by the helical conveyor.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Solid particles, such as those used in pharmaceuticals, are often coated to improve shelf life, mask tastes and odors, or modify the release of active ingredients. Different manners of coating particles have been developed.

A fluidized bed occurs when a quantity of solid particles (generally contained in a holding vessel such as a fluid bed processor) are placed under appropriate conditions to cause the particles to behave as a fluid. This may be done by movement of air, gas, or other fluids through the bed of solid particles. This causes the aggregate solids to acquire properties and attributes similar to those of normal fluids, resulting in what is known as fluidization. Fluidized beds are commonly used in the pharmaceutical industry to dry, granulate, and coat active pharmaceutical ingredients (APIs), excipients, or other formulations.

The fluid bed granulation process (also known as agglomeration) involves suspending particles in an air stream and spraying a liquid, often from the top of the system, onto the fluidized bed. Particles in the path of the spray get slightly wet and become sticky. The sticky particles collide with one another in the fluidized bed and adhere to form granules.

In wet stage granulation, the particles require moisture or granulating solution before they become tacky enough to stick to each other. The granulating solution is applied until the particles build up enough moisture to granulate.

Wurster coating technology was developed by Dr. Dale Wurster, leading to the creation of the Wurster fluid bed coating process. The basic concept in Wurster coating is to separate the particles in the fluid bed from one another in an air (gas) stream. While the particles are suspended, a coating formulation is sprayed from the bottom of the bed up onto the particles (i.e., bottom-up spray). More specifically, an air stream separates and suspends the particles in a fluid bed. A coating formulation is sprayed from the bottom of the bed onto the particles. The coating dries or congeals while the particles are suspended.

The Wurster process has been used for years to coat particles such as powders, prills, pellets, crystalline material, extrudates, tablets, capsules, and the like. Systems have been developed for use with a variety of coating formulations, including aqueous/organic solutions, suspensions, emulsions, and hot melts.

The Wurster fluid bed coating processes uses a cylindrical partition mounted above a coating nozzle in the bottom of the fluidized bed of particles. The partition provides a physical separation between the upward travelling particles that have been recently wetted with coating and those that are dried and/or cooled and are falling back into the fluidized bed. This coating process is ideally suited to the individual coating of particles from fine powders (approximately 10 μm) up to small pellets (2-3 mm) and is commonly used across several industries.

The process takes place inside a fluid bed 1 that is divided into two zones by the partition 2, shown in FIG. 1. The inner area 3 is a high velocity zone that separates the particles 4 and pneumatically transports them past the coating nozzle 10 in a high velocity air stream 5. After passing the nozzle 10, the particles 4 enter the expanded area 6 of the chamber, slow down and fall back into the outer section 7 of the fluid bed product bowl 8. The coating dries or congeals while the particles 4 are suspended to prevent agglomeration from occurring when they enter the low-velocity part of the bed.

The coated particles in the particle bed remain sufficiently fluidized to allow them to continue moving towards the bottom 9 of the bowl 8. When the particles 4 reach the bottom 9, they are drawn back into the high velocity air stream 5 and the cycle is repeated. This process continues until the desired level of coating has been achieved.

Traditional small-particle fluid bed coating processes use fluidization air through specially designed air distribution plates to cycle particles past a coating nozzle. Wurster Coating and other fluid bed coating processes rely on process air being pulled through the equipment (or more rarely pushed through) by a blower. This air combined with a perforated air distribution plate (bottom 9 in FIG. 1), provides for the fluidization of the particle bed and the cyclic flow of the particles past the coating nozzle, upward into an expansion chamber for drying and/or cooling, and then gravitational return of the particles back to the fluid bed where the coating cycle continues until sufficient coating weight gain or thickness is realized.

Although Wurster Fluid Bed Coating remains one of the most economical and efficient means for film coating of small particles across several industries, it has some limitations.

Due to differences in pneumatic transport and settling velocities, particles of disparate size, density, or surface morphology may cycle at different rates and receive different coating levels during processing.

As an example, a well-designed Wurster Fluid Bed with proper processing conditions will cycle like particles at a relatively consistent, uniform rate. When particles of substantially different sizes are fluidized in the same fluid bed, the smaller particles will cycle through the process less than the larger counterparts assuming that the fluidizing air is sufficient to fluidize the largest particles. The small particles follow a longer cycle path both in time and distance because they travel higher in the expansion chamber and have a slower settling velocity than the larger particles. As a result, the smaller particles receive less coating than the large particles, because they pass by the coating nozzle less frequently. When the goal of the coating process is complete encapsulation of every particle, or for a specific coating thickness, this issue becomes a concern because smaller particles have a larger surface area by weight than larger particles. Put another way, the population of particles that require the most coating, get the least. For this reason, Wurster Coating processes often target a particle size distribution where the largest particles are no more than five times the diameter of the smallest.

The processing air in a Wurster Coater is not only required for the fluidizing and cycling of particles in the fluid bed, but also provides most of the drying capacity for coating preparations utilizing aqueous or organic solvent vehicles. Particles passing by the nozzle are coated, travel upward inside the coating equipment, and the process air evaporates the water or organic solvent from the surface of the particle before it falls back into the bed to repeat the cycle again. The vaporized vehicle then typically exits the coater for possible incineration or recovery, and then is discharged. Large fluid beds can require several thousand liters of process air every hour. This makes use of alternative fluidizing gases, such as nitrogen or argon, rare in fluid bed coating processes. Doing so would require large volumes of the source gas and special attention to avoiding leaks that could pull atmospheric air into the system as the coating processes are typically under negative pressure to the surrounding workspace. Alternatively, the process air can be recycled though the coating process, but this requires specialized equipment such as desiccant wheels, adsorbents, and chillers to remove the solvent prior to reuse of the air. Otherwise, the process air will eventually become saturated with the solvent.

The continuous cycling of particles in traditional fluid beds via process air along with the air-atomized coating nozzles that are often used, can impart sufficient strain to the particles being coated to cause attrition of those core particles or even breakage of the coating during or after application.

Tablets cycled in a traditional fluid bed need to be extremely robust to stand up to the repeated lift and drop into the particle bed; otherwise chipping and breakage is observed. Two-piece capsules can also be coated in a fluid bed but the movement of the action of the fluidization and the high-pressure atomization air from a coating nozzle can cause premature separation of the capsule shells. This not only makes the separated capsule non-viable, but also can foul the coating of the other capsules by contaminating their surfaces.

The present invention aims to rectify some of the limitations of traditional fluid bed coating and have additional capabilities that do not exist in prior art.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a system for coating using a helical conveyor. The system may comprise a chamber with a stationary helix surrounded by a cylindrical casing mounted at or near a bottom surface of the chamber. A coating nozzle, also referred to as a spray nozzle, is provided at or near the top of the chamber. The casing is rotated about the axis of the helix by a drive underneath the chamber or another suitable means. Voids at the bottom of the casing allow particles to flow into the base of the helix. One or more scoops near those voids, either integral to or attached to the casing, encourage transport of the particles into the casing voids and to the base of the helix when the casing is rotated in the proper direction. Continued rotation of the casing causes the particles to flow upward through the helix until they reach the top of the casing and then fall back into the particle bed. An additional landing area may be positioned at the top of the casing. The landing area may be integral to or attached to the casing. The landing area increases horizontal travel of the particles before they fall back into the particle bed.

Coating is applied as the particles cycle through the system. In some embodiments, the coating nozzle that delivers a coating liquid is generally centered above the top of the helix and casing. The height of the nozzle and relative position to the particles exiting the casing can be adjusted for optimal coating efficiency.

The coating processes disclosed herein can be useful in both batch and continuous manufacturing.

In another aspect, the present disclosure provides a method for coating particles, the method comprising: providing a chamber comprising a first coating chamber a bottom surface, a first helix positioned proximate the bottom surface of the chamber, a first casing provided about the helix, the casing having an open top and a bottom; and at least one void provided proximate the bottom of the casing, wherein particles flow through the at least one void towards the helix. The method further comprises rotating either the casing or the helix to introduce particles into the helix and draw the particles towards the open top and coating the particles with a coating liquid.

In another aspect, the present disclosure provides a system including helical conveyors for use in coating particles, the system comprising: a first coating chamber having a top portion and a bottom surface; a first helix positioned proximate the bottom surface of the chamber; a first casing provided about the helix, the casing having an open top and a bottom; and at least one void provided proximate the bottom of the casing, wherein particles flow through the at least one void towards the helix. The system further comprises a conveyor configured to deliver particles from the first coating chamber to a second coating chamber. The second coating chamber has a top portion and a bottom surface; a second helix positioned proximate the bottom surface of the chamber; a second casing provided about the helix, the casing having an open top and a bottom; and at least one void provided proximate the bottom of the second casing, wherein particles flow through the at least one void towards the second helix. The system is configured such that at least some of the particles are coated with a coating liquid before entering the second chamber.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 illustrates a Wurster coating system.

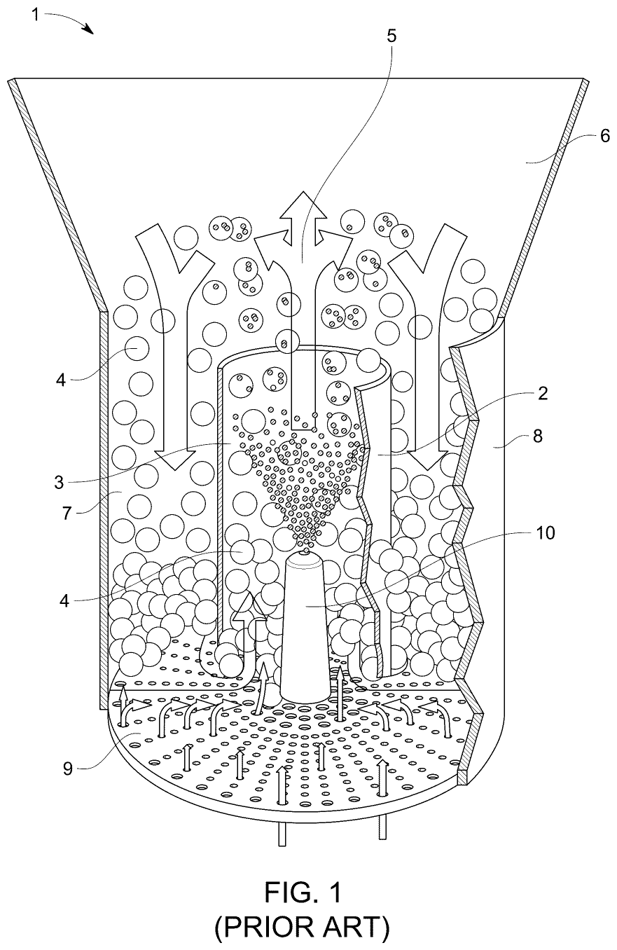

FIG. 2 illustrates a cross-sectional view of a system for coating using a helical conveyor, in accordance with embodiments of the present disclosure.

FIG. 3 illustrates an open top view of a system for coating using a helical conveyor, in accordance with embodiments of the present disclosure.

FIG. 4 illustrates a side view chamber of the system for coating using a helical conveyor, in accordance with one embodiments of the present disclosure.

FIG. 5 illustrates a top side view of aspects of components provide interior of the chamber of the system for coating using a helical conveyor, with the chamber walls and casing omitted, in accordance with embodiments of the present disclosure.

FIG. 6 illustrates a side view of aspects of components provided interior to the chamber of the system for coating using a helical conveyor, with the chamber walls omitted, in accordance with embodiments of the present disclosure.

FIG. 7 illustrates a top side perspective view of FIG. 6.

FIG. 8 illustrates a system for coating in a continuous manufacturing process featuring a plurality of chambers each including a helical conveyor, in accordance with embodiments of the present disclosure.

FIG. 9 illustrates a close up view of a gate controlling travel of particles between two chambers of the system of FIG. 8, in accordance with embodiments of the present disclosure.

### DETAILED DESCRIPTION

The present disclosure relates to a novel and advantageous system for coating particles. Particularly, the present disclosure relates to a novel and advantageous system for coating particles using a helical conveyor. Even more particularly, the present disclosure relates to a novel and advantageous system for coating particles using a helical conveyor wherein vertical movement and cycling of material is generally governed by the helical conveyor.

In various embodiments, the helical conveyor comprises a chamber, a helix, a casing, and a spray nozzle. The helix is provided within the casing and the casing is provided within the chamber. The chamber has a top portion and a bottom surface. The helix may be provided proximate the bottom surface of the chamber and is surrounded by the casing. The spray nozzle may be provided proximate the top of the chamber.

In one or more embodiments, a system for coating using a helical conveyor is provided. The system may comprise a chamber with a stationary helix surrounded by a cylindrical casing mounted at or near the bottom surface of the chamber. A coating nozzle, also referred to as a spray nozzle, is provided at or near the upper surface of the chamber. The casing is rotated about the axis of the helix by a drive underneath the chamber or another suitable means. Voids at the bottom of the casing allow particles to flow into the base of the helix. One or more scoops are provided near the voids to facilitate transport of the particles into the casing towards the helix when the casing is rotated. The scoops may be separate from, coupled to, or integral with the casing. Continued rotation of the casing causes the particles to flow upwardly through the helix until they reach the top of the casing, exit the casing, and fall back to the particle bed. An additional landing area may be positioned at the top of the casing. The landing area may be integral to or attached to the casing. The landing area increases horizontal travel of the particles before they fall back into the particle bed.

Coating is applied as the particles cycle through the system. In some embodiments, the coating nozzle that delivers a coating liquid is generally centered above the top of the helix and casing. The height of the nozzle and relative position to the particles exiting the casing can be adjusted for optimal coating efficiency.

In order to cycle particles past the coating nozzle, vertical movement and cycling of material through the chamber using the system provided herein is generally governed by the casing assembly, which comprises the helix, casing, and scoops. The system thus does not rely on fluidizing air and therefore does not have the particle size limitations of a fluid bed coater. Because the helix and casing conveyance is volumetric, it can cycle a range of combined particle sizes with minimal classification. For example, there is no requirement that the largest particles to be no more than five times larger than the smallest. More uniform coating on a batch of disparately sized particles is thus provided using the system for coating using a helical conveyor as described herein as compared to fluid bed coating.

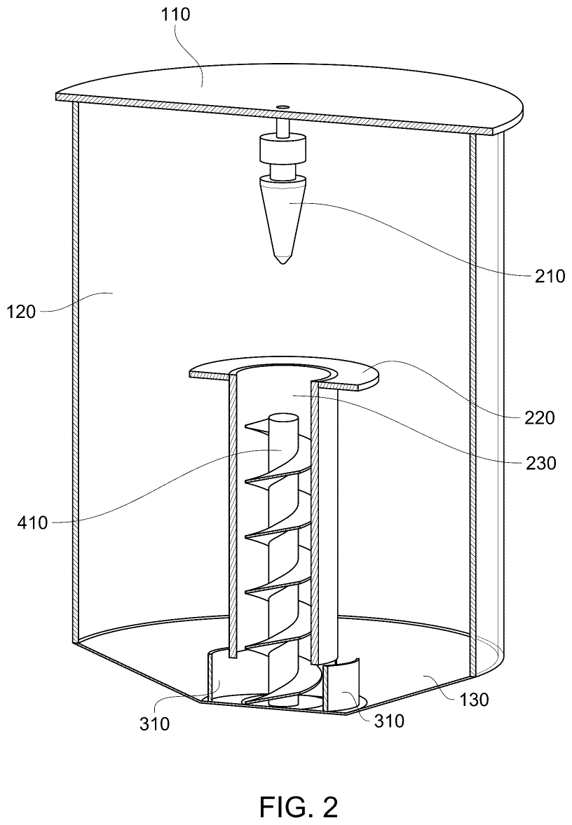

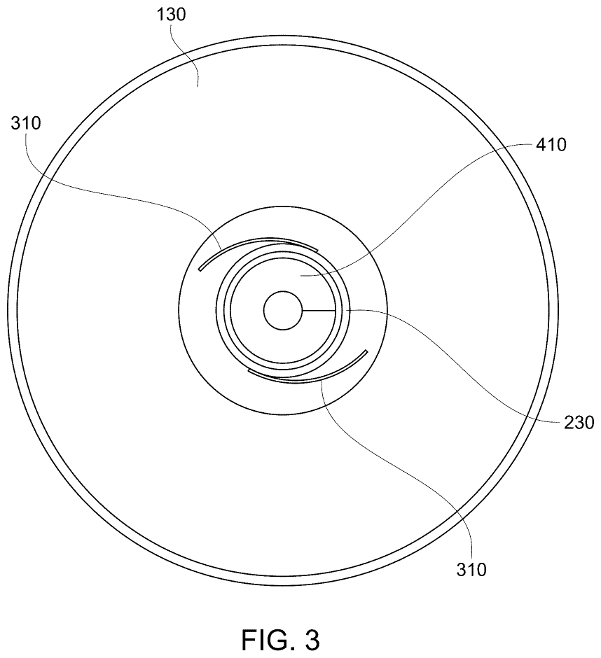

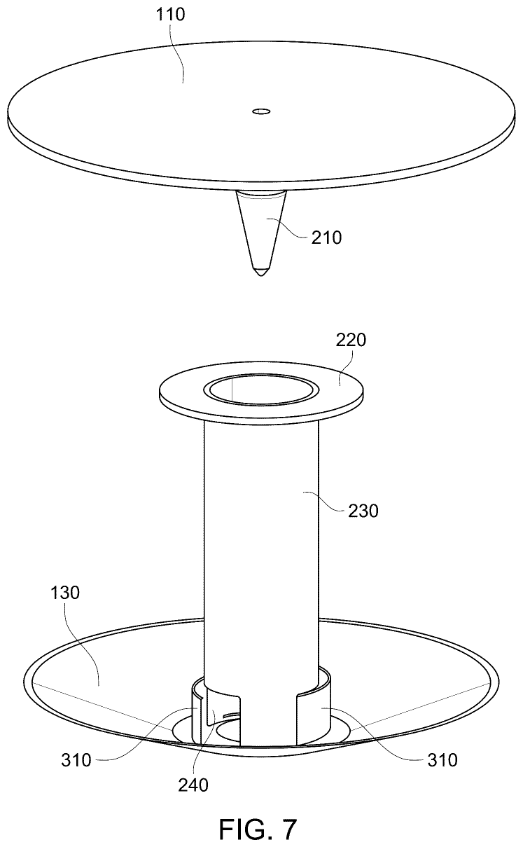

FIG. 2 illustrates a cross-sectional side view of a system for coating using a helical conveyor, in accordance with one embodiment. FIG. 3 illustrates a top view of the system for coating using a helical conveyor, in accordance with one embodiment. As shown, the system includes a chamber, a casing 230 provided within the chamber, a helix 410 provided within the casing 230, and a coating nozzle 210 provided above the casing 230 at or near the interior top of the chamber. The chamber has chamber walls 120, a base 130, and an optional lid 110. The casing includes voids 240 (visible in FIG. 7) and scoops 310 at a lower portion thereof and an optional landing surface 220 at an upper portion thereof. It is to be appreciated that references to a helix or helixes generally include any spiral inclined plane such as an auger, screw, coil, or ribbon.

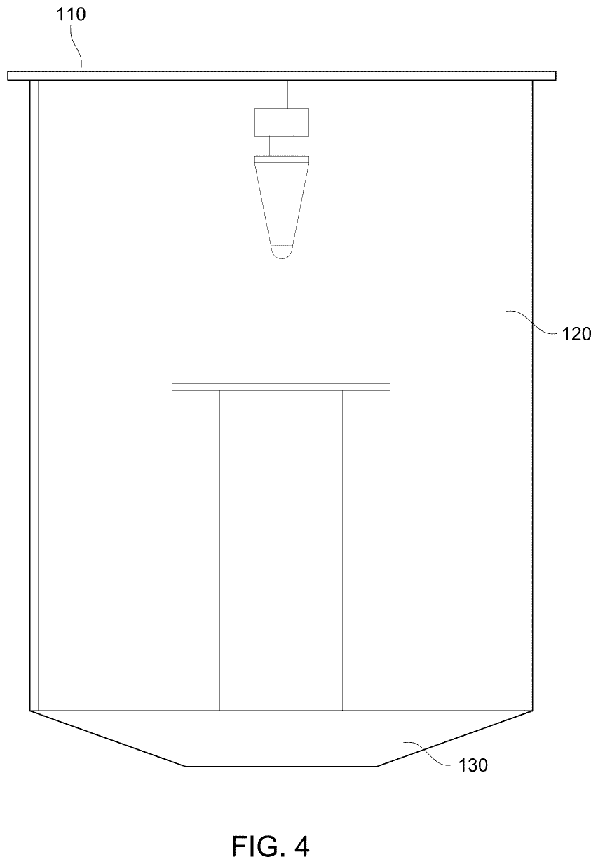

FIG. 4 illustrates a side view chamber of the system for coating using a helical conveyor, in accordance with one embodiment. As shown, the chamber walls 120 which may be provided cylindrically around the casing. In other embodiments, the walls 120 may be angled in any suitable configuration such that the particles being coated are directed into the scoops 310 of the casing 230. The particles may comprise, for example, powders, prills, crystalline material, extrudates, tablets, capsules, or the like. The chamber may be any suitable shape and size to generally contain particles within the chamber. In one embodiment, the chamber comprises transparent acrylic material. In other embodiments, other materials may be used.

In some embodiments, the base 130 of the chamber comprises a perforated plate that allows flow of processing air through the chamber. Such processing air may be used for heating, cooling, or removal of residual solvents (aqueous or organic). This may be accomplished by orienting the chamber within a traditional fluid bed coater so that conditioned process air or another suitable gas can be pulled or pushed through the perforated plate and bed of particles at the base of the chamber. Alternatively, the base 130 of the chamber may comprise a continuous, non-porous plate having a mounting area for receiving the casing 230 and helix 410 generally centrally thereto. The casing 230 and helix 410 may be mounted in a manner allowing for rotation of the casing 230. The base 130 of the chamber may be flat or angled to encourage movement of particles into the scoops 310. In an example embodiment, the base 130 of the chamber is sloped downward from the exterior chamber wall 120 at a 45°angle.

The top of the chamber may be open to the work area or may have an optional lid 110 that can be sealed during processing to avoid contamination of the process or materials escaping the process. The lid may also serve as a mounting area for the coating nozzle 210.

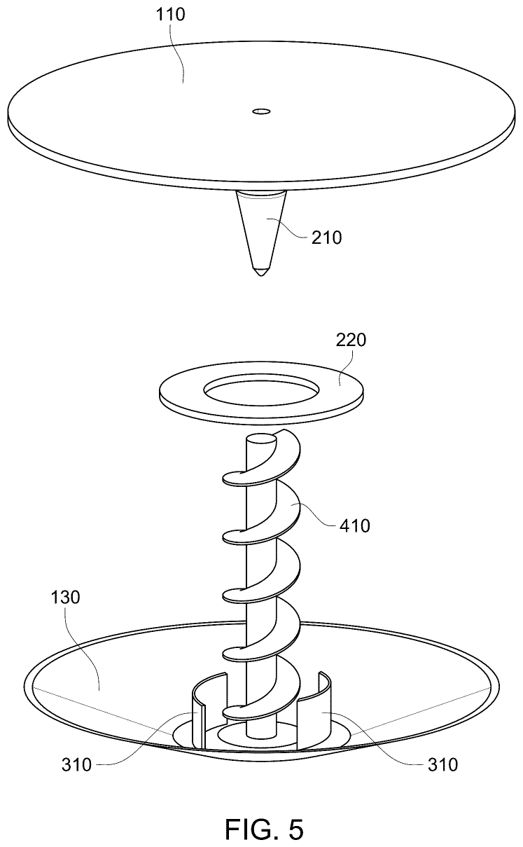

FIG. 5 illustrates a top side view of aspects of components provided interior of the chamber of the system for coating using a helical conveyor, in accordance with one embodiment. More specifically, FIG. 5 illustrates a chamber lid 110, a spray nozzle 210, a helix 410, optional landing surface 220, scoops 310, and a base 130 of the chamber. As shown, the chamber base 130 may be sloped downwardly towards the casing and helix to encourage flow of the particle bed into the scoops 310 as they direct particles into voids 240 of the casing 230.

One or multiple stationary helixes 410 may be mounted at the chamber base. These may be of any suitable length, diameter, and pitch sufficient to convey materials along with the rotating casing 230. In one embodiment, the chamber has a 45-cm internal diameter and 64-cm height; with a casing of 10-cm internal diameter and 35-cm height; encasing a helix with 9-cm diameter, 30-cm height, and 9-cm pitch. In another embodiment, the chamber has a 30.5-cm internal diameter and 29.2-cm height; with a casing of 8.3-cm internal diameter and 33-cm height; encasing a helix with 7.6-cm diameter, 30.5-cm height, and 7.6-cm pitch. The chamber, casing, and helix may have dimensions within the ranges established by example embodiments or may be outside such a range for the demands of the coating process. Different diameters, inclines, and clearances between the helix and the casing may be utilized for different particles depending on the particle characteristics to be conveyed, such as size, shape, density, surface morphology, and flowability.

One or more voids 240 (seen in FIG. 7) provided at or near a bottom portion of the casing 230 allow particles to flow into the base of the helix 410. The voids 240 may be of any suitable size or shape sufficient to allow for said particle flow. In one embodiment, two voids are placed opposite one-another, extending to 5 cm above the bottom of the casing and extending to 9 cm along the circumference of the casing. In general, the voids are sized to discourage particle flow out of the helix 410 and back into the particle bed (i.e., the accumulation of particles within the chamber, including those adjacent the casing 230). A scoop 310 is provided proximate each void. The scoops 310 encourage particles to flow into the helix 410 when the casing 230 is properly rotated. The scoops 310 may be integral to or attached to the casing 230. In one embodiment the scoops 310 are 5-cm high and protrude 7 cm from the edge of each void In another embodiment, scoops 310 are 7.6-cm high, have a 2.3-cm open width, and protrude 7 cm from the edge of each void. The scoops may have dimensions within the ranges established by the example embodiments or may be outside such a range for the demands of the coating process. Different scoop and void sizes and shapes may be installed for different particles depending on the particle characteristics to be conveyed, such as size, shape, density, surface morphology, and flowability. Adapting these dimensions can allow for a wider range of particle sizes that can be coated by the systems of the present disclosure than prior art processes.

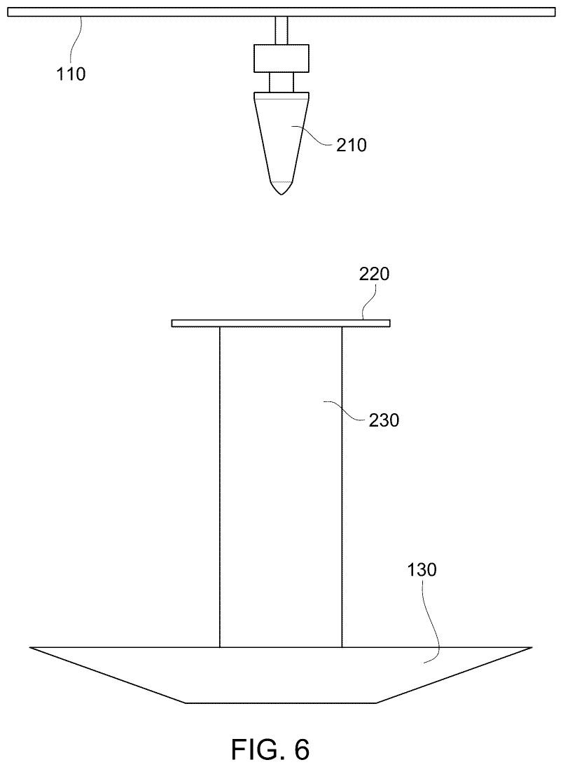

FIG. 6 illustrates a side view aspects of components provided interior to the chamber of the system for coating using a helical conveyor, in accordance with one embodiment. FIG. 7 illustrates a top side perspective view of FIG. 6. More specifically, FIGS. 6 and 7 illustrate a chamber lid 110, a spray nozzle 210, and a casing 230 having a landing surface 220. The casing 230 is provided on or proximate to a base 130 of the chamber.

The casing 230 encompasses the helix 410. The casing may be cylindrical or may have other suitable shape for encouraging particle flow therethrough. One or more voids 240 are provided at a lower portion of the casing 230. In some embodiments, the casing 230 extends beyond the top of the helix 410. When the flow of particles reaches the top of the helix 410, those particles are still retained within the casing 230 so that a volume of the particles covers the top of the helix 410 before reaching the top of the casing 230. Observing the particle flow from above, the helix 230 would not be visible. This minimizes contact of coating liquid with the top of the helix 410 when delivered from above. The casing 230 may be rotated independently of the stationary helix 410 and chamber base 130. The interface of the casing 230, the helix 410, and the chamber base 130 may be sealed to minimize wear therebetween, preventing vertical movement of the helix 410, and preventing leakage of the particles from the chamber as they are cycled.

In some embodiments, an optional landing surface 220 is provided at or near the top of the casing 230. The landing surface 220 allows conveyed particles to flow out the top of the casing 230 and horizontally across the landing surface 220 before falling back into the particle bed. The horizontal flow increases exposure time as the coating is applied from above.

The helix 410, casing 230, and chamber base 130 are oriented in such a way that the casing 230 is allowed to rotate along its vertical axis while the helix 410 and chamber base 130 remain stationary. The parts are installed and configured to enable such movement while discouraging particles from flowing therebetween and out the bottom of the chamber base 130. Rotation of the casing 230 may be driven by any suitable rotary means. In some embodiments, rotation of the casing 230 may be driven from below by a belt, gear drive, or other similar mechanism (not shown). Alternatively, the casing 230 may be driven from the sides or above.

In some embodiments, the chamber walls 120, the chamber base 130, the casing 230, and/or the helix 410 may be heated or cooled to assist with processing. Additional protrusions may be added to these parts to increase surface area and heat exchange between the particles and the conditioned parts.

Operation of the system for coating using a helical conveyor will now be described.

The particles to be coated are added to the chamber. Generally, sufficient particles are loaded into the chamber to provide adequate volume to fill the casing 230 and helix 410 assembly while also entirely covering the voids at the bottom of the casing to discourage outflow from the bottom of the helix 410 into the particle bed. The particles are contained within the chamber at the bottom by the chamber base 130 and on the sides by the chamber walls 120.

Rotation of the casing 230 and scoops 310 about the helix 410 is driven. This may be, for example, from below the chamber using a motor with a belt or gear drive. The casing 230 rotates in a direction such that a leading edge of the scoops 310 guide particles into the voids of the casing while the helix 410 remains stationary. In the figures shown, rotation is counter-clockwise when viewed from above. In other configurations, rotation may be clockwise. A sloped chamber base 130 encourages flow of the particle bed into the scoops 310 as they direct particles into the casing voids.

Continued rotation of the casing 230 forces more particles into the voids 240 via the scoops 310 and the particles begin to travel vertically up the helix 410. Friction between the particles inside the helix 410 and inner walls of the casing 230 encourages flow of the particles up the helix 410 in direction towards the nozzle 210. As the particles reach the top of the helix 410, they are confined within the top of the casing 230 until they reach an open upper end thereof. In the embodiment shown, a landing surface 220 is provided at the open upper end. Once no longer confined by the casing 230, the particles spill out of the casing 230 and back down to the particle bed. When a landing surface 220 is provided, the particles spill horizontally across the landing surfaces 220 and cascade back down into the particle bed.

The cycling of the particles continues as long as the casing 230 is rotated in a direction guiding particles into the voids 240. At steady state, the same volume of material entering the voids 240 of the casing 230 spills out the open end of the casing and replenishes. The speed of conveyance through the casing 230 and helix 410 assembly is approximately proportional to the rotational speed of the casing 230 such that doubling the speed of casing 230 rotation will approximately double the volume of particles cycled over a given time period. This proportional relationship permits greater control over the coating process.

A spray nozzle 210 provided at an upper portion of the chamber applies coating liquid such as molten wax or hydrogenated vegetable oil. In the embodiment shown, the spray nozzle 210 is oriented directly above the center of the helix 410. Properly atomized, small droplets of the liquid are delivered from the nozzle 210, contact the particles flowing across the landing 220, and congeal on contact or as the particles fall back into the particle bed. In an example embodiment for coating pellets, the opening of the nozzle is spaced 12-cm from the open end of the casing, the spray rate of the coating liquid is 37 g/min, and the nozzle has an atomization air pressure of 3.4 to 17.2 kPa. The height of the nozzle above the open end of the casing, the spray rate of coating liquid from the nozzle, and the atomization conditions of the nozzle may be adjusted to avoid spray drying or spray congealing of the coating liquid and agglomeration of particles for optimized encapsulation of the individual particles.

The top of the casing 230, sitting vertically proud above the top of the helix 410, prevents coating of the helix 410 because it is covered by the particles being conveyed. The landing surface 220 increases the potential for the coating spray contact or the particles by increasing horizontal travel of the particles under the nozzle 210.

Sufficient cycling time of the particles past the spray of the nozzle 210 results in exposure of all particle surfaces and the iterative process of spray droplet contact and congealing results in a uniform coating across all particles. For long coating processes, a build-up of heat from the elevated temperature of the coating liquid may be avoided through cooling of one or more of the particle-contact surfaces (chamber walls 120, chamber base 130, scoops 310, casing 230, helix 410, and landing 220) or by the introduction of conditioned air into the chamber.

When sufficient coating thickness or weight gain (e.g., about 23% by weight, based on the total weight of the coated particle) has been realized, the spray from the coating nozzle 210 is stopped and the coated particles can be removed from the chamber. Removal of the coated particles may be by any suitable means such as a vacuum, ports in the chamber base 130 or walls 120, or inversion of the entire chamber assembly to empty by gravity (with optional lid 110 removed). Rotation of the casing 230 in a direction opposite the direction to fill the voids empties most of the particles from the helix 410 back to the chamber through the chamber voids.

The described system for coating using a helical conveyor can cycle particles larger than can typically be fluidized by processing air alone. Where typical tablets can be difficult to coat with a fluid bed, the described system can cycle particle sizes several times larger and with minimal attrition. The helical coater allows for more gentle cycling of particles within the chamber that can minimize the issues of tablet friability and capsule separation.

The described system for coating using a helical conveyor does not rely on air for conveyance of particles past the coating nozzle. Instead, conveyance is provided by the helix and the casing. This allows for a somewhat sealed coating apparatus that may be purged with an inert or other gas. This is useful for the coating of moisture sensitive, oxygen sensitive, and even pyrophoric materials. The described system further has a much smaller footprint than a traditional fluid bed coater. The traditional expansion chamber that can make up over 80% the height of a Wurster Coater, is not required for the helical described. Furthermore, the additional utilities and space for a process air blower and process air conditioning are not needed.

The present disclosure provides a method for coating particles using the above described system for coating using a helical conveyor. In a first step, a volume of particles to be coated is introduced into the chamber to form a particle bed exterior to the casing. In a second step, the casing and scoops are rotated to draw the particles through the voids. The rotation of the casing may occur during or subsequent to the introduction of the particles. In a third step, the particles are drawn through the helix towards an open end of the casing. In a fourth step, the spray nozzle introduces the coating liquid into the chamber, coating the particles as they emerge from the open end of the casing. Optionally, the particles may continue to be coated on a landing adjacent the open end. Next, the particles fall back into the particle bed. These steps may be repeated until a sufficient number of particles reaches the desired coating weight. As a last step, the particles may be removed from the chamber via, for example, inversion.

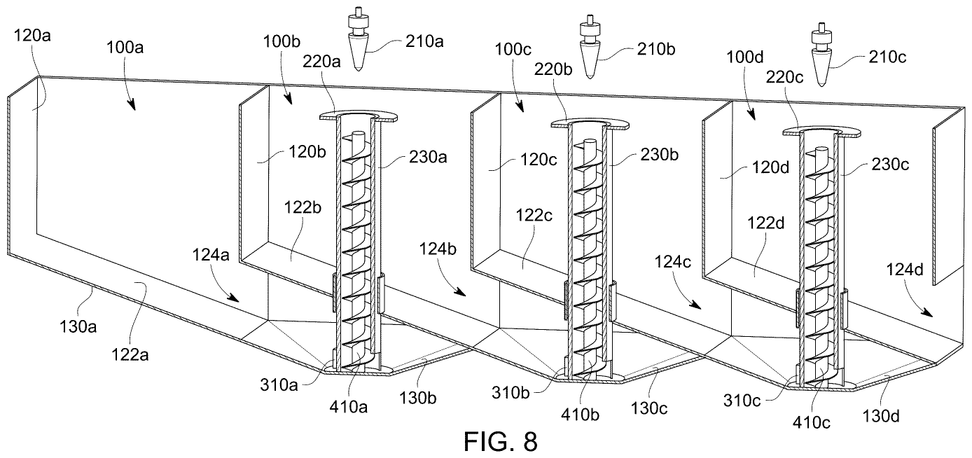

The benefits provided by a helical conveyor may be realized across multiple, connected coating chambers. A system for coating using a plurality of helical conveyors 410a, 410b, and 410c held within separate coating chambers 100b, 100c, and 100d is depicted in FIG. 8. Lids for the chambers are omitted from the depiction, but each chamber may include a lid to, e.g., support the spray nozzle or enclose the system. Individual elements within the system represented by FIG. 8 share features and considerations with the like numbered elements described above, and the discussion above for each applies mutatis mutandis to the systems and methods described below unless the context expressly suggests otherwise. Chambers 100a, 100b, 100c, and 100d within the system may share chamber walls as depicted, or may include a gap between at least one of walls.

The system includes an introductory chamber 100a (i.e., hopper) for receipt of a volume of particles for coating, though the chamber lacks a casing, helical conveyor, or spray nozzle. The introductory chamber 100a includes a sloped base 130a (typically at an angle of 135° as measured from chamber wall 120a) forming a chute 122a and chute opening 124a to a first coating chamber 100b. Particles delivered into the hopper 100a flow down the chute 122a through the opening 124a into the base 130b of the first coating chamber 100b.

The first coating chamber 100b includes a first spray nozzle 210a, and a casing 230a having a landing surface 220a. The casing 230a is provided on or proximate to a base 130b of the chamber 100b and encompasses a first helix 410a. As shown, the chamber base 130b may be sloped downwardly towards the casing 230a and helix 410a to encourage flow of the particle bed into the scoops 310a as they direct particles into voids (not shown) of the casing 230a. Particles are drawn upwards through continued rotation of the casing 230a and the spray nozzle 210a introduces a first coating liquid into the chamber 100b, coating the particles as they emerge from the open end of the casing 230a.

The first coating chamber includes a chute 122b comprising a sloped surface disposed above the base 130b. The casing 230a may extend through the chute 122b and may be sealed to minimize wear therebetween and preventing leakage of the particles from the chute towards the base 130b as they are cycled. Rather than recycled through the casing 230a, the coated particles are delivered to a second coating chamber 100c through a chute opening 124b in the chamber wall 120c.

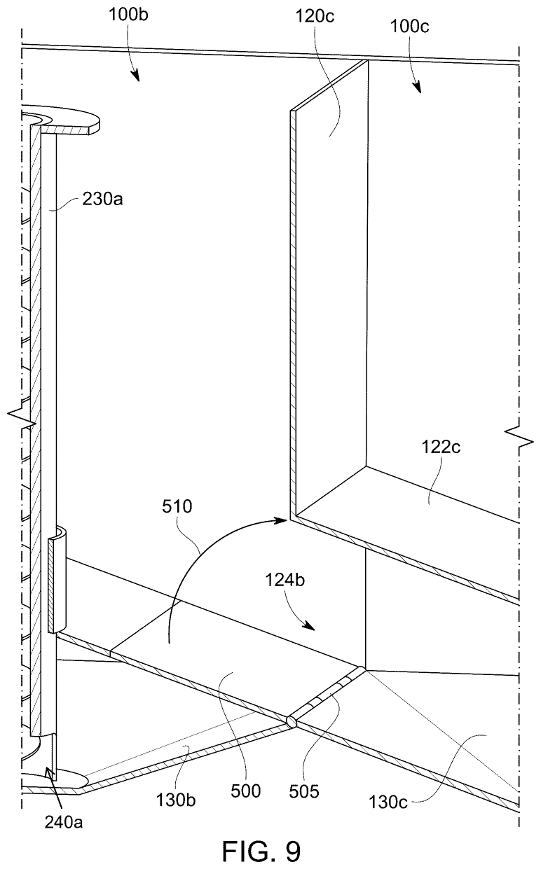

In some embodiments, the chute 122b extends around a portion of the casing 230a and only partially covers the base 130b. This permits the coated particles emerging from the open end of the casing 230a or the landing 220a to cascade downwardly towards the base 130b, whereby they are reintroduced into the casing 230a and helix 410a for additional coating. In other embodiments, the chute 122b prevents any particles from reentering the casing 230a, and the chamber 100b is responsible for a single coating cycle. In some such embodiments, including the one depicted in FIG. 9 below, the chute may include one or more gates or doors that are configured to permit flow of particles to the base 130b when open and flow towards the second coating chamber 100c when closed.

The second coating chamber 100c includes a second spray nozzle 210b, and a casing 230b having a landing surface 220b. The casing 230b is provided on or proximate to a base 130c of the chamber 100c and encompasses a second helix 410b. As shown, the chamber base 130c adjacent the chute opening 124b may be sloped downwardly towards the casing 230b and helix 410b to encourage flow of the particle bed into the scoops 310b as they direct particles into voids (not shown) of the casing 230b. Particles are drawn upwards through continued rotation of the casing 230b and the spray nozzle 210b introduces a second coating liquid into the chamber 100c, again coating the particles as they emerge from the open end of the casing 230b.

Aspects of the second coating chamber 100c may be the same or different than the first coating chamber 100b. For instance, the composition of second coating liquid may be the same or different than the composition of the first coating liquid or may be heated to a different temperature. As other examples, the spray rate, rotational speed of the casing, or any of the component dimensions may be the same or different. For instance, the second casing 230b may rotate a slower speed than first casing 230a. In other embodiments, the aspects of the first and second coating chambers 100b, 100c are substantially the same.

The second coating chamber 100c also includes a chute 122c comprising a sloped surface disposed above the base 130c. Rather than recycled through the casing 230b, at least some of the coated particles are delivered to a third coating chamber 100d through a chute opening 124c in the chamber wall 120d. Like the first coating chamber 100b, the chute 122c may only partially cover the base 130c, permitting some of the coated particles to cascade downwardly towards the base 130c, whereby they are reintroduced into the casing 230b and helix 410b for additional coating, or the chute 122c may fully cover the base 130c and prevent the reentry of any particles into the casing 230b.

The third coating chamber 100d includes a third spray nozzle 210c, and a casing 230c having a landing surface 220c. The casing 230c is provided on or proximate to a base 130d of the chamber 100d and encompasses a third helix 410c. As shown, the chamber base 130d adjacent the chute opening 124c is sloped downwardly towards the casing 230c and helix 410c to encourage flow of the particle bed into the scoops 310c as they direct particles into voids (not shown) of the casing 230c. The third spray nozzle 210c introduces a third coating liquid into the chamber 100d, again coating the particles as they emerge from the open end of the casing 230c.

Aspects of the third coating chamber 100d may be the same or different than either or both of the first coating chamber 100b and the second coating chamber 100c. For instance, the composition of third coating liquid may be the same as the composition of the first coating liquid and different from the second coating liquid. As other examples, the spray rate, rotational speed of the casing, or any of the component dimensions may be the same or different. Any two or all of the spray nozzles may draw from a common reservoir of coating liquid. Each casing may be driven independently or through a common drive.

The third coating chamber 100d also includes a chute 122d comprising a sloped surface disposed above the base 130d, with the chute 122d configured to permit re-coating (as described above) or deliver all the coated particles cascading from the casing 230c out the chamber 100d through the chute opening 124d. If a desired coating weight has been reached, the particles may be collected in a container (not shown) or submitted to subsequent processing, which may include reintroduction into the hopper 100a.

In addition to or in lieu of chutes, the multi-chamber system of FIG. 8 may include gates between each of the coating chambers. When closed, the particles stay within the chamber, recycling past the nozzle; when open, the coated particles would flow to the next section. The gates could remain closed for some period of time allowing for the coating liquid to build up as much as desired, with the gate opening to allow the material to flow into the next chamber. The gate opening and closing may be sequenced to minimize the mixing of the new incoming particles and the previously coated particles. Such embodiments could rely on a chutes as depicted or other conveyors (e.g., belts or forced air) to transition particles between coating chambers.

For example and as depicted in FIG. 9, the gate 500 may form a portion of the chute 122b when open, and a portion of the chamber wall 120c when closed. FIG. 9 illustrates a gate between first and second coating chambers 100b, 100c, but a gate may be used between any two chambers (e.g., 100a and 100b, or 100c and 100d) in the systems of the present disclosure. Such a gate may include a pivot 505 (e.g., a hinge) proximate the chute opening 124b, permitting rotation of the gate about an axis. To close the chamber, the gate may be rotated about the pivot axis along path 510 in a direction away from the casing 230a to close the chute opening 124b. In some such embodiments, the chute 122b may fully cover the base 130b when the gate 500 is open and may accordingly only permit particles to reach the base 130b (and subsequently re-enter the voids 240a) when the gate 500 is closed or partially closed. When partially closed, the gate may still funnel some particles into the subsequent coating chamber 100c, while allowing others to reenter the casing 230a.

Though only three coating chambers are depicted in FIG. 8, those skilled in the art will appreciate that additional coating chambers featuring the helical conveyors of the present disclosure may be added in series, without any appreciable upper limit. Similarly, the skilled person will appreciate that a hopper chamber may be used with only one or two coating chambers. The continuous processing offers considerable adaptability in creating multi-material coatings, or processing higher volumes of particles.

The present disclosure provides a method for coating particles using the above described multi-chamber system. In a first step, a volume of particles to be coated is introduced into the hopper. In a second step, the particles are delivered to a first coating chamber including a casing and helix. The casing and scoops are rotated to draw the particles through the voids in the casing. The rotation of the casing may occur during or subsequent to the introduction of the particles. In a third step, the particles are drawn through the helix towards an open end of the casing. In a fourth step, the spray nozzle introduces the coating liquid into the chamber, coating the particles as they emerge from the open end of the casing. Optionally, the particles may continue to be coated on a landing adjacent the open end. Next, at least some of the coated particles cascade from the casing onto a conveyor (e.g., a chute), where they are delivered through an opening into a second coating chamber including a second casing, helix, and spray nozzle.

The second casing and associated scoops are rotated to draw the particles through the voids in the second casing. The particles are then drawn through the second helix towards an open end of the second casing and the second spray nozzle introduces the coating liquid into the second coating chamber, coating the particles as they emerge from the open end of the casing. Next, at least some of the particles cascade from the second casing onto a manual or automated conveyor (e.g., a chute), where they are delivered through an opening into a third coating chamber including a third casing, helix, and spray nozzle.

The third casing and associated scoops are rotated to draw the particles through the voids in the third casing. The particles are then drawn through the third helix towards an open end of the third casing and the third spray nozzle introduces the coating liquid into the third coating chamber, coating the particles again as they emerge from the open end of the casing. Next, at least some of the particles cascade from the third casing onto a manual or automated conveyor (e.g., a chute), where they are delivered to another stage and retained for subsequent storage or processing.

These steps may be repeated until a sufficient number of particles reaches the desired coating weight. Particles may be fed continuously into hopper, or in batches. Transitions between chambers may occur naturally (e.g., via operation of the chute) or may be gated.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A helical conveyor system for use in coating particles, the system comprising:
a chamber having a top portion and a bottom surface;
a helix positioned proximate the bottom surface of the chamber;
a casing provided about the helix, the casing having an open top and a bottom; and
at least one void provided proximate the bottom of the casing, wherein particles flow through the at least one void towards the helix.

2. The system of claim 1, wherein the helix is stationary.

3. The system of claim 2, wherein the casing is rotated about the helix.

4. The system of claim 3, wherein rotation of the casing causes the particles to move upwardly about the helix and out of the top of the casing.

5. The system of claim 1, further comprising a landing area at the top of the casing.

6. The system of claim 1, further comprising at least one scoop, wherein the scoop encourages flow of the particles through the void.

7. The system of claim 1, wherein the casing is cylindrical.

8. The system of claim 1, further comprising a coating nozzle.

9. The system of claim 8, wherein the coating nozzle is provided proximate the top of the chamber.

10. The system of claim 1, further comprising a lid.

11. The system of claim 10, wherein the nozzle extends downwardly from the lid.

12. A method for coating particles, the method comprising:
providing a chamber comprising a first coating chamber a bottom surface;
a first helix positioned proximate the bottom surface of the chamber;
a first casing provided about the helix, the casing having an open top and a bottom; and at least one void provided proximate the bottom of the casing, wherein particles flow through the at least one void towards the helix;
rotating either the casing or the helix to introduce particles into the helix and draw the particles towards the open top;
coating the particles with a coating liquid.

13. The method of claim 12, wherein the chamber further comprises a spray nozzle, and wherein the coating the particles comprises delivering the coating liquid through the spray nozzle.

14. The method of claim 12, wherein the helix is fixed and the casing is rotated about the helix, and wherein rotation of the casing causes the particles to move upwardly about the helix and out of the top of the casing.

15. The method of claim 12, and further comprising allowing the coated particles to return to base of the casing.

16. The method of claim 15, wherein the coated particles are reintroduced into the helix and drawn towards the open top.

17. The method of claim 12, wherein the chamber further comprises at least one scoop, wherein the scoop encourages flow of the particles through the void.

18. The method of claim 17, and further comprising inverting the chamber to remove at least some of the coated particles.

19. A system including helical conveyors for use in coating particles, the system comprising:
a first coating chamber having a top portion and a bottom surface;
a first helix positioned proximate the bottom surface of the chamber;
a first casing provided about the helix, the casing having an open top and a bottom; and
at least one void provided proximate the bottom of the casing, wherein particles flow through the at least one void towards the helix;
a first conveyor configured to deliver particles from the first coating chamber to a second coating chamber, the second coating chamber having a top portion and a bottom surface;
a second helix positioned proximate the bottom surface of the chamber;
a second casing provided about the helix, the casing having an open top and a bottom; and
at least one void provided proximate the bottom of the second casing, wherein particles flow through the at least one void towards the second helix,
wherein the system is configured such that at least some of the particle are coated with a coating liquid before entering the second chamber.

20. The system of claim 19, and further comprising a second conveyor configured to deliver particles from the second coating chamber to a third coating chamber, the third coating chamber having a top portion and a bottom surface; a third helix positioned proximate the bottom surface of the third chamber; a third casing provided about the third helix, the third casing having an open top and a bottom; and at least one void provided proximate the bottom of the third casing, wherein particles flow through the at least one void towards the third helix.
